(19) United States
(12) Patent Application Publication
(10) Pub. No.: US 2026/0362068 A1
(43) Pub. Date: Nov. 12, 2026

(54) HEARING AID SYSTEM AND METHOD FOR CONFIGURING SUCH

(71) Applicant: WIDEX A/S, Lynge (DK)

(72) Inventor: Soeren Bredahl GREINER, Roskilde (DK)

(73) Assignee: WIDEX A/S, Lynge (DK)

(21) Appl. No.: 19/123,242

(22) PCT Filed: Oct. 25, 2023
(86) PCT No.: PCT/EP2023/079808

§ 371 Date: Apr. 22, 2025

(30) Foreign Application Priority Data
Oct. 28, 2022 (DK) PA202270521

(51) Int. Cl. H04R 25/00

(52) U.S. Cl. CPC H04R 25/554; H04R 2225/55

(57) ABSTRACT

A hearing aid system is provided. The hearing aid system has: a hearing aid; an audio transmitter; and a control device; wherein the audio transmitter is configured to transmit audio signal data to the hearing aid at a specific audio periodicity. The hearing aid is configured to, while receiving audio signal data from the audio transmitter, upon establishing contact with the control device and at a predetermined update periodicity, send data relating to the specific audio periodicity of the audio signal data to the control device. The control device is configured to use the data relating to the specific periodicity of the audio signal data to only send control data to the hearing aid when the hearing aid does not receive audio signal data. A method for configuring such a hearing aid system is further provided.

### TECHNICAL FIELD

The present inventive concept relates to a hearing aid system and a method for configuring such. More specifically, the present inventive concept relates to a hearing aid system that automatically corrects for drift between its components.

### BACKGROUND

Modern hearing aids are connectable to media devices such as smart phones or televisions to receive audio streams directly from the media devices. However, the hearing aid may also receive audio from other sources at the same time, such as from another person. Even though the hearing aid may only receive audio from one transmitter at a time, e.g. either a television or another person via an external microphone or control device, it is desirable to maintain a data connection with both audio sources in order to e.g. receive remote commands or quickly be able to start a new audio stream.

This presents a challenge in that while the hearing aid receives an audio stream from one device with an isochronous link, the connection to the other device may have a poor data link because its data packages are being sent at the same time as the hearing aid is receiving the audio stream. Because the audio experience of a user is usually more important than data packages from an idle connection, this may lead to total link loss from the inactive audio streamer. This is especially difficult to avoid because of a drift in time signatures between the different audio streamers.

In the prior art, this may be addressed by calculating said drift and requiring one of the audio streamers to correct for the drift when transmitting signals. However, the drift may still change over time and both the hearing aid and the audio streamers may be very processor-limited, limiting the possibilities for addressing the drift in this specific scenario.

### SUMMARY

It is thereby an object of the present inventive concept to improve a connection stability of a hearing aid when receiving audio from an audio transmitter and simultaneously maintaining an idle connection to a control device. This and other objects are achieved by the features set out in the appended independent claims, with embodiments set out in the dependent claims.

Accordingly, a first aspect of the inventive concept is provided by a hearing aid system. The hearing aid system comprises: a hearing aid; an audio transmitter; and a control device; wherein the audio transmitter is configured to transmit audio signal data to the hearing aid at a specific audio periodicity; the hearing aid is configured to, while receiving audio signal data from the audio transmitter, upon establishing contact with the control device and at a predetermined update periodicity, send data relating to the specific audio periodicity of the audio signal data to the control device; and the control device is configured to use the data relating to the specific periodicity of the audio signal data to only send control data to the hearing aid when the hearing aid does not receive audio signal data.

By the specific audio periodicity of the audio transmitter is meant a periodicity at which the audio transmitter transmits audio signal data, e.g. two packets of left-ear data and two packets of right-ear data during a period of 3000 μs and a period of no data packets for 7000 μs before repeating the process. Note that this periodicity is set according to an internal clock of the audio transmitter, which may drift in relation to real time.

By sending data relating to the specific audio periodicity of the audio signal upon establishing contact with the control device and at a predetermined update periodicity, any drift will be corrected for before it starts to affect the connection without a need to calculate the drift or when to update. This requires relatively very little processing power and memory.

The data relating to the specific audio periodicity of the audio signal data may comprise a (relative or absolute) timestamp when the hearing aid does not receive audio signal data from the audio transmitter.

In the case of a relative timestamp, the timestamp is relative to the package carrying the timestamp information. This may simplify the receiver side, because this enables the receiver to add the relative timestamp to the time that the package was received in the receiver's own internal clock, to compute the time of an event.

This timestamp is optimally set as a compromise. The timestamp benefits from being far enough removed from any audio signal data that is transmitted from the audio transmitter to not drift into overlap before the next update according to the update periodicity, which is more energy efficient the longer it is. However, it is also beneficial to be close enough in time to any audio signal data that is transmitted from the audio transmitter to leave time for other signals and processing time.

The hearing aid system may further comprise a personal device connected to the control device, wherein the control device is further configured to receive control data and/or audio signal data from the personal device and transmit said control data and/or audio signal data to the hearing aid only when the hearing aid does not receive audio signal data from the audio transmitter.

The personal device may e.g. be a smart phone or computer. The connection between the personal device and the control device may e.g. be Bluetooth®, WiFi or other suitable fast, low energy alternatives.

The personal device may be configured to control, via the control device, whether the hearing aid is receptive to audio signal data originating from the audio transmitter or the personal device.

By enabling the control device this level of control, a user may use the control device to better understand and affect the audio signals they receive.

The audio transmitter may perform audio processing on the audio signal data before being transmitted to the hearing aid.

The audio processing may e.g. be to correct for lag or enhancing dialogue.

The hearing aid system may further comprise a media device configured to transmit the audio signal data to the audio transmitter.

The media device may e.g. be a television or computer. The transmission to the audio transmitter may be wireless or wired, e.g. via an optical fiber. The media device may also send other data to e.g. improve audio processing.

The audio transmitter and control device may each comprise an internal clock that drifts in relation to each other.

This drift may cause the transmitted signals to overlap e.g. every 5 minutes. In this case, the update periodicity would be shorter than 5 minutes, e.g. 4 minutes.

The control device may comprise a microphone for detecting audio signals from external sources; and the control device may be further configured to transmit said audio signals from external sources to the hearing aid only when the hearing aid does not receive audio signal data from the audio transmitter.

The external sources may e.g. be another person. The microphone may be integrated with the control device or external to the control device.

The audio transmitter may be configured to frequency-hop when transmitting audio signal data to the hearing aid.

Frequency-hopping comprises changing the frequency at which the audio transmitter broadcasts signals, and this change may be controlled by a hopping algorithm. The hearing aid may know the hopping algorithm of the audio transmitter, e.g. by receiving it upon first connecting to the audio transmitter.

Frequency-hopping is beneficial in that it reduces any risk that the specific broadcast frequency of the audio transmitter is being blocked.

According to a second aspect of the invention, a method for configuring a hearing aid system is provided. The method comprises steps of: transmitting, by an audio transmitter, an audio data stream and data relating to a specific audio periodicity of audio signal data of the audio data stream; receiving, by a hearing aid, the transmission of the audio transmitter; advertising, by the hearing aid, that it is available for connection; scanning, by a control device, the advertisement of the hearing aid; transmitting, by the hearing aid, the data relating to the specific audio periodicity to the control device; transmitting, by the control device, a time to connect to the hearing aid when the hearing aid does not receive audio signal data based on the data relating to the specific audio periodicity; and connecting the control device and the hearing aid at the time to connect.

This method requires relatively little processing power and memory and enables a more stable connection between the hearing aid, audio transmitter and control device.

The step of connecting the control device and the hearing aid may further comprise setting a time to update the data relating to the specific audio periodicity.

The method may further comprise steps of: receiving, by the hearing aid, updated data relating to the specific audio periodicity; and updating the time to connect the control device and the hearing aid based on the updated data relating to the specific audio periodicity.

Updating further improves reliability of the connections.

The step of transmitting by the audio transmitter may comprise frequency-hopping and transmitting a hopping algorithm controlling the frequency hopping.

Frequency-hopping is beneficial in that it reduces any risk that the specific broadcast frequency of the audio transmitter is being blocked.

The transmitting, by the control device, a time to connect to the hearing aid based on the data relating to the specific audio periodicity may comprise choosing a time that has a long enough minimum slide time while also being close enough to any audio signal data transmission to leave time for other signals and processing time.

Slide time is a window in time where no collisions occur due to drift in relation to audio signal data transmissions. A longer slide time enables a less frequent correction for drift.

This enables a balance to be struck to find an improved time for the control device to connect to the hearing aid.

### DESCRIPTION OF DRAWINGS

The invention will be described in further detail with reference to preferred aspects and the accompanying drawing, in which:

FIG. 1 shows a schematic view of a hearing aid system according to an embodiment;

FIG. 2 shows a schematic view of signals sent and received in the hearing aid system according to an embodiment;

FIG. 3 shows a flowchart of a method of configuring a hearing aid system according to an embodiment;

FIG. 4 shows a schematic view of signals sent and received in the hearing aid system according to an embodiment; and

FIG. 5 shows a schematic view of signals sent and received in a hearing aid of the hearing aid system according to an embodiment.

### DESCRIPTION OF EMBODIMENTS

In the following, terms such as a/an/the and comprising are intended to be interpreted as non-limiting. Any processor or computing unit may be implemented as an electronic circuit and electronic connections may be wired or wireless unless otherwise explicitly stated. Unless explicitly specified, a wireless connection may be implemented in any number of standards known to a person skilled in the art, such as Wi-Fi, Bluetooth®, Zigbee, 4G/LTE, 5G and so one.

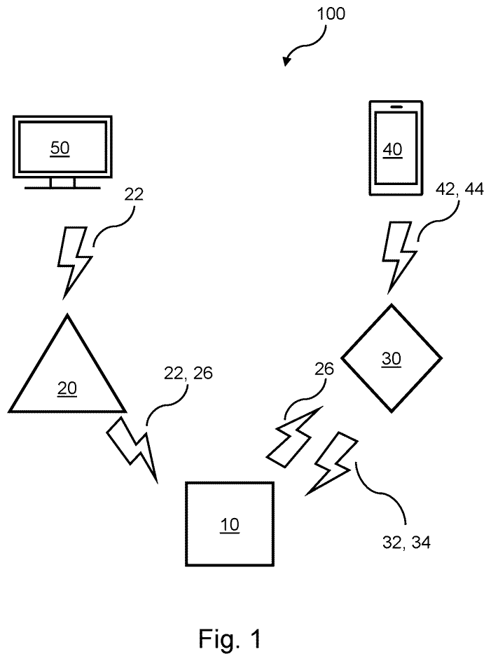

FIG. 1 shows an embodiment of a hearing aid system 100. The hearing aid system 100 comprises a hearing aid 10, an audio transmitter 20, and a control device 30. The hearing aid system 100 in FIG. 1 further comprises a personal device 40 and a media device 50.

The audio transmitter 20 is configured to transmit audio signal data 22 to the hearing aid 10 at a specific audio periodicity.

The audio transmitter 20 may e.g. be a broadcaster that has or receives audio signals to be delivered to the hearing aid 10 using specifically adapted communication protocols to reduce lag and improve connection fidelity.

The audio transmitter 20 may be configured to frequency-hop when transmitting audio signal data to the hearing aid 10.

Frequency-hopping map comprise having e.g. three different frequency bands that are predetermined. The audio transmitter 20 will transmit on each of the different bands and will send audio data packets alternating between each of the different bands, according to an hopping algorithm. The hearing aid 10 will listen for transmissions on each of the bands when looking to connect to the audio transmitter, and will then either receive the hopping algorithm from the audio transmitter 20 or know it previously, so that the hearing aid 10 receives on alternating different bands as the audio transmitter 20 transmits on them.

The audio transmitter 20 may be configured to perform audio processing on the audio signal data 22 before being transmitted to the hearing aid 10. This may e.g. involve converting traditional electrical audio signal data to data adapted for use with a hearing aid.

The hearing aid 10 is configured to, while receiving audio signal data 22 from the audio transmitter 20, upon establishing contact with the control device 30 and at a predetermined update periodicity, send data 26 relating to the specific audio periodicity of the audio signal data to the control device 30.

The update periodicity may e.g. be every minute, every 3-10 minutes, or every 5 minutes. The update periodicity may be predetermined during manufacturing or using software updates and be based on a worst-case drift based on assumptions on temperature and crystal-tolerances.

The update periodicity may be updated using data collected during use, e.g. based on a drift measured or calculated in the hearing aid system.

The data 26 relating to the specific audio periodicity of the audio signal data 22 may be received by the audio transmitter 20 or generated by the hearing aid 10.

The data 26 relating to the specific audio periodicity may be derived from transmitting and/or receiving the audio signal data 22 and may be different from any parameters influencing the transmission of the audio signal data 22.

The data 26 relating to the specific audio periodicity of the audio signal data 22 may comprise a timestamp when the hearing aid 10 does not receive audio signal data 22 from the audio transmitter 20.

The data 26 relating to the specific audio periodicity of the audio signal data 22 may comprise an offset between audio signal data packets, an offset between the audio signal data packets and an advertising signal (of the hearing aid 10 or another unit of the system 100), and/or an offset between different connection points.

The control device 30 is configured to use the data 26 relating to the specific periodicity of the audio signal data 22 to only send control data 34 to the hearing aid 10 when the hearing aid 10 does not receive audio signal data 22.

The control device 30 may comprise a microphone for detecting audio signals 32 from external sources, such as another person. This microphone may be external to the control device 30, or e.g. be internal to the control device 30.

The control device 30 may e.g. comprise a unit mounted to a partner of a hearing aid user with an internal microphone and Bluetooth® connection to a personal device 40.

The control device 30 may further be configured to transmit said audio signals 32 from external sources to the hearing aid 10 only when the hearing aid 10 does not receive audio signal data 22 from the audio transmitter 20.

The audio transmitter 20 and control device 30 may each comprise an internal clock that drifts in relation to each other. This drift may mean that even if the audio transmitter 20 and control device 30 send data packets at times that do not interfere with each other, their respective understanding of these times will drift over time so that eventually, they may overlap.

Drift is part of a reason that updating the data 26 relating to the specific audio periodicity of the audio signal data 22 is beneficial, as this will automatically correct for drift between the update events.

The hearing aid system 100 in FIG. 1 further comprises a personal device 40. The personal device 40 is connected to the control device 30, wherein the control device 30 is further configured to receive control data 44 and/or audio signal data 42 from the personal device 40 and transmit said control data 44 and/or audio signal data 42 to the hearing aid 10 only when the hearing aid 10 does not receive audio signal data 22 from the audio transmitter 20.

The control data 44 and/or audio signal data 42 of the personal device 40 may or may not be the same as the control data 34 and audio signal data 32 of the control device 30.

The personal device 40 may e.g. be a smart phone of the user running an app that allows the user, e.g. via the control device 30 or acting as the control device 30, to e.g. control settings of the hearing aid 10 or play music through the hearing aid 10.

The personal device 40 may further control whether the hearing aid 10 is receptive to audio signal data 22, 42 originating from the audio transmitter 20 or the personal device 40.

The hearing aid system 100 in FIG. 1 further comprises a media device 50. The media device 50 is configured to transmit the audio signal data 22 to the audio transmitter 20. The media device 50 may e.g. be a television or a smart phone.

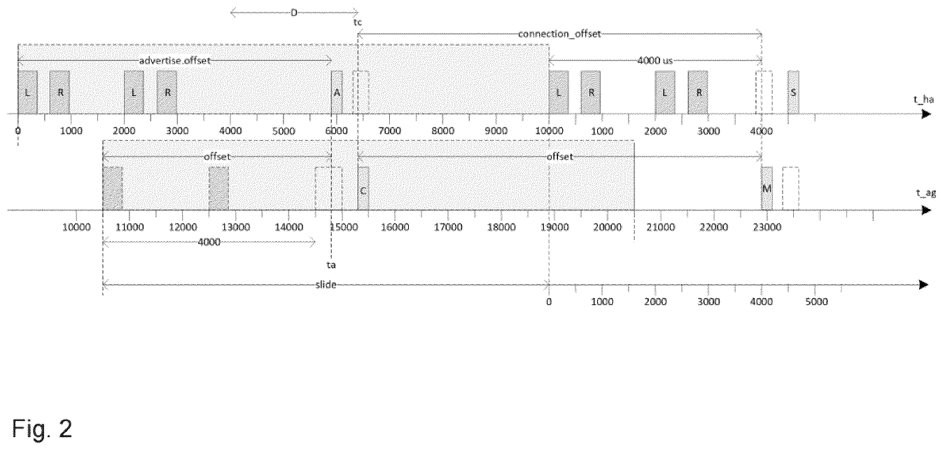

FIG. 2 shows a schematic view of signals sent and received in the hearing aid system of FIG. 1. The top chart represents signals received and sent by the hearing aid. The bottom chart represents signals received and sent by the control device to the hearing aid.

The L and R packets in the top chart is audio signal data, in this case relating to the left and right ear, respectively. These are sent to the hearing aid by the audio transmitter, so the hearing aid is actively listening to audio signal data from the audio transmitter.

The A packet in the top chart is an advertising packet, notifying other units that the hearing aid is available for (idle) connection. The leftmost dash-lined packets in the bottom chart are the control device scanning for connections/advertisements.

As the A packet overlaps with the control device scanning for connection, a process for connecting the hearing aid with the control device is started. The control device sends a C packet with information relating to how and when to connect. This may make use of data relating to the specific periodicity of the audio signal data, which may be broadcasted to the control device in the A packet or sent separately after the process for connecting the hearing aid with the control device is started.

The data relating to the specific periodicity of the audio signal data may comprise information relating to an advertising offset and the timing of receiving the L and R packets.

Later in the process, at a time when the hearing aid does not receive audio signal data, the connection of the hearing aid with the control device is completed by the control device sending an M packet that may comprise control data and/or an update periodicity. The hearing aid may then respond with an S packet that may comprise a verification and/or the update periodicity.

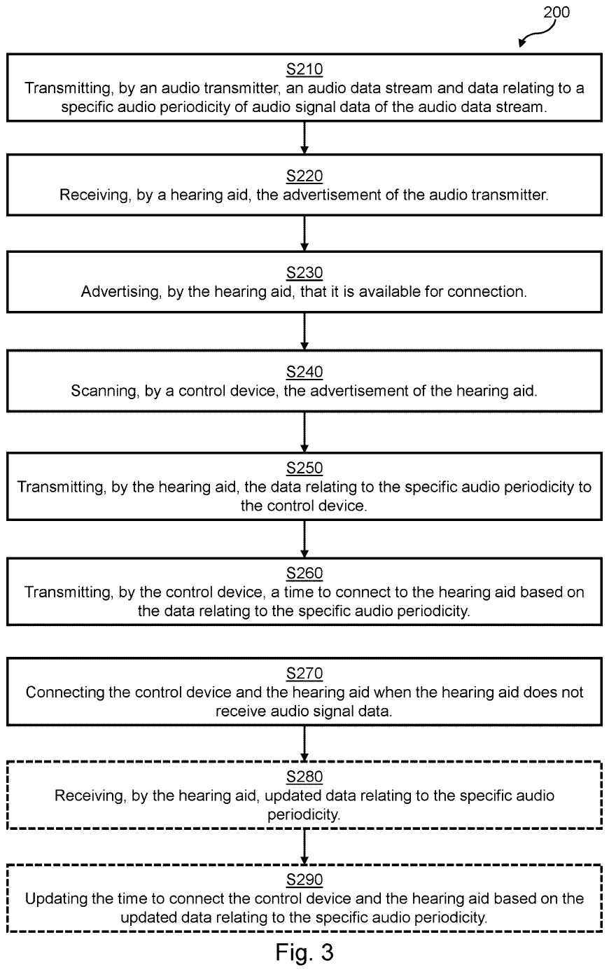

FIG. 3 shows a flowchart of a method 200 for configuring a hearing aid system, such as the system in FIG. 1. The method 200 comprises several steps, which may occur in a different order than shown, with some steps being simultaneous or overlapping. The steps shown with dashed lines are optional.

In the method 200 shown, the first step is transmitting S210 an audio data stream and data relating to a specific audio periodicity of audio signal data of the audio data stream. This step S210 is performed by an audio transmitter of the hearing aid system.

This may comprise frequency-hopping and transmitting a hopping algorithm controlling the frequency hopping.

The next step is receiving S220, by a hearing aid, the transmission of the audio transmitter.

The next step is advertising S230, by the hearing aid, that it is available for connection.

Next, the advertisement of the hearing aid is received by a control device by the control device scanning S240 for advertisements.

The next step is transmitting S250, by the hearing aid, the data relating to the specific audio periodicity to the control device. This step S250 may be performed at the same time as or at a different time than the advertising step S230, and the data relating to the specific audio periodicity may or may not be included in the advertising data.

The next step is transmitting S260, by the control device, a time to connect to the hearing aid based on the data relating to the specific audio periodicity.

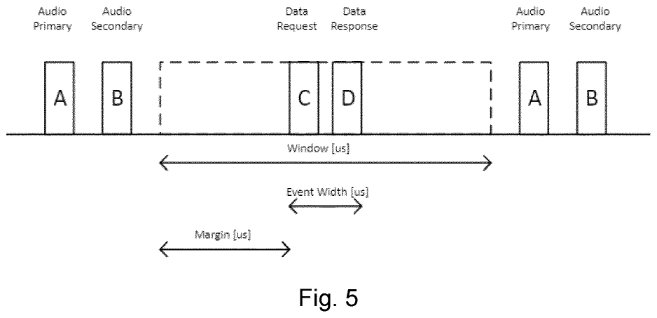

This transmitting step S260 may comprise choosing a time that has a long enough minimum slide time while also being close enough to any audio signal data transmission to leave time for other signals and processing time. That is to say, the transmitting step S260 may comprise choosing a time that is far enough removed from a window in time where no collisions occur due to drift compared to audio signal data transmissions. This will be discussed in more detail with reference to FIG. 5.

The next step is connecting S270 the control device and the hearing aid when the hearing aid does not receive audio signal data.

This step S270 may comprise setting a time to update the data relating to the specific audio periodicity.

This step S270 may correspond to the M signal packet in FIG. 2.

The next step is receiving S280, by the hearing aid, updated data relating to the specific audio periodicity.

The final step is updating S290 the time to connect the control device and the hearing aid based on the updated data relating to the specific audio periodicity. This step may be performed by the hearing aid or the control device.

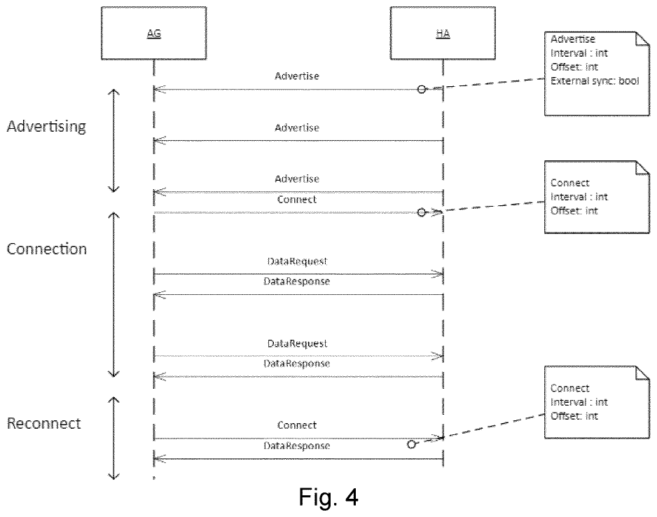

FIG. 4 shows a schematic view of signals sent and received in a hearing aid system, such as the hearing aid system of FIG. 1. The left part of FIG. 4 represents signals received and transmitted by a control device of the hearing aid system. The right part of FIG. 4 represents signals received and transmitted by a hearing aid of the hearing aid system.

The hearing aid advertises at a predetermined interval. The control device scans for such an advertisement at another predetermined interval. At some point, the advertisement and scan coincide (as seen in FIG. 2), which initiates a connection between the hearing aid and the control device.

The advertisement may comprise information about an offset of the advertisement compared to e.g. audio signals received by an audio transmitter of the audio system, i.e. data relating to a specific audio periodicity of audio signal data.

When the control device has found an advertise packet it initiates connection by responding to the advertisement. This comprises transmitting a connect packet to the hearing aid, which may contain information about connection interval, time offset and radio channels of the control device.

Once the connection is established, the control device sends a package (data request) with a periodicity determined by the connection interval and time offset, and the hearing aid responds to every connection event (data response).

The control device may adjust the time offset and connection interval by sending a new connect package (reconnect) to the hearing aid containing a new connection interval and offset. This may comprise sending a connection request at the time the control device would normally send a data request.

Such an adjustment may be configured to occur at every X data request, where X is a predetermined or calculated number that corresponds to a suitable time between adjustments to ensure that any drift between different signals received by the hearing aid do not cause these signals to interfere with each other.

This may correspond to setting a time to update data relating to specific audio periodicity in FIG. 3, where the reconnect portion of FIG. 4 corresponds to the steps of receiving S280 updated data relating to the specific audio periodicity and updating S290 the time to connect of FIG. 3.

FIG. 5 shows a schematic view of signals sent and received in a hearing aid of a hearing aid system, such as the hearing aid system of FIG. 1.

The A and B packets may correspond to the L and R packets of FIG. 2. The C and D packets may correspond to the A and C packets of FIG. 2, i.e. a connection event between a hearing aid and a control device of the hearing aid system.

FIG. 5 shows a window that corresponds to a span of time where a connection event may occur without collisions occurring between different signals.

FIG. 5 also shows an event width, which corresponds to a span of time where signals are being exchanged during a connection event.

FIG. 5 further shows a margin, which corresponds to a distance in time from the connection event and the border of the window, i.e. between different exchanges of signals,

[symbol]

Due to clock drift between the control device and an audio transmitter of the hearing aid system, the connection event may slowly drift out of the window where no collisions occur. A collusion may cause these signals to interfere with each other and is therefore beneficial to avoid.

A time it takes for this clock drift to cause the connection event to slide out of the window is called slide time. The shortest slide time is the distance from the connection event to the border of the window, which corresponds to the margin divided by the drift speed.

In FIG. 5, the connection event may be initially placed in the center of the window. This is not necessarily ideal, because while it maximises the minimum slide time it also limits time available for other signals. The connection event may therefore in other embodiments be selected to optimise these different considerations, which is done in FIG. 2.

As an example, the window is 5000 μs, the event width is 500 μs, the margin is (window-event width)/ 2, i.e. 2250 μs, and the drift is 25 μs/s. This gives a shortest slide time of 90 s. This would mean that in order to avoid collisions between signals, which may cause data loss, the timing of the connection event should be corrected at least every 90 s.

The preceding description has been a non-exhaustive disclosure of different exemplifying embodiments of the present inventive concept. This is not to be misconstrued as limiting the scope of the protection sought for the inventive concept, which is defined by the appended claims.

1. A hearing aid system comprising:
a hearing aid;
an audio transmitter; and
a control device;
wherein the audio transmitter is configured to transmit audio signal data to the hearing aid at a specific audio periodicity;
the hearing aid is configured to, while receiving audio signal data from the audio transmitter, upon establishing contact with the control device and at a predetermined update periodicity, send data relating to the specific audio periodicity of the audio signal data to the control device; and
the control device is configured to use the data relating to the specific periodicity of the audio signal data to only send control data to the hearing aid when the hearing aid does not receive audio signal data

2. The hearing aid system according to claim 1, wherein the data relating to the specific audio periodicity of the audio signal data comprises a timestamp when the hearing aid does not receive audio signal data from the audio transmitter.

3. The hearing aid system according to claim 1, further comprising a personal device connected to the control device, wherein the control device is further configured to receive control data and/or audio signal data from the personal device and transmit said control data and/or audio signal data to the hearing aid only when the hearing aid does not receive audio signal data from the audio transmitter.

4. The hearing aid system according to claim 3, wherein the personal device is configured to control, via the control device whether the hearing aid is receptive to audio signal data originating from the audio transmitter or the personal device.

5. The hearing aid system according to claim 1, wherein the audio transmitter is configured to perform audio processing on the audio signal data before being transmitted to the hearing aid.

6. The hearing aid system according to claim 1, further comprising a media device configured to transmit the audio signal data to the audio transmitter.

7. The hearing aid system according to claim 1, wherein the audio transmitter and control device each comprise an internal clock that drifts in relation to each other.

8. The hearing aid system according to claim 1, wherein the control device comprises a microphone for detecting audio signals from external sources; and
the control device is further configured to transmit said audio signals from external sources to the hearing aid only when the hearing aid does not receive audio signal data from the audio transmitter.

9. The hearing aid system according to claim 1, wherein the audio transmitter is configured to frequency-hop when transmitting audio signal data to the hearing aid.

10. A method for configuring a hearing aid system comprising steps of:
transmitting by an audio transmitter, an audio data stream and data relating to a specific audio periodicity of audio signal data of the audio data stream;
receiving by a hearing aid, the transmission of the audio transmitter;
advertising by the hearing aid, that it is available for connection;
scanning by a control device, the advertisement of the hearing aid;
transmitting by the hearing aid, the data relating to the specific audio periodicity to the control device;
transmitting by the control device, a time to connect to the hearing aid when the hearing aid does not receive audio signal data based on the data relating to the specific audio periodicity; and
connecting the control device and the hearing aid at the time to connect.

11. The method according to claim 10, wherein the step of connecting the control device and the hearing aid further comprises setting a time to update the data relating to the specific audio periodicity; and
the method further comprises steps of:
receiving by the hearing aid, updated data relating to the specific audio periodicity; and
updating the time to connect the control device and the hearing aid based on the updated data relating to the specific audio periodicity.

12. The method according to claim 10, wherein the step of transmitting by the audio transmitter comprises frequency-hopping and transmitting a hopping algorithm controlling the frequency hopping.

13. The method according to claim 10, wherein the transmitting, by the control device, a time to connect to the hearing aid based on the data relating to the specific audio periodicity comprises choosing a time that has a long enough minimum slide time while also being close enough to any audio signal data transmission to leave time for other signals and processing time.
